(19) United States
(12) Patent Application Publication
(10) Pub. No.: US 2023/0404840 A1
(43) Pub. Date: Dec. 21, 2023

(54) RECIPROCATING MASSAGE TABLE

(71) Applicant: EPIONIC EASE BED CORP., Langley (CA)

(72) Inventor: Francis Arthur SWITZER, Langley (CA)

(21) Appl. No.: 18/461,273

(22) Filed: Sep. 5, 2023

Related U.S. Application Data
(62) Division of application No. 17/106,796, filed on Nov. 30, 2020.
(60) Provisional application No. 62/941,947, filed on Nov. 29, 2019.

(30) Foreign Application Priority Data
Nov. 29, 2019 (CA) 3063455

(51) Int. Cl. A61H 7/00

(52) U.S. Cl. CPC A61H 7/004; A61H 7/007; A61H 2205/081; A61H 2201/0142; A61H 2201/1669

(57) ABSTRACT

A reciprocating massage table includes a base frame, and a reciprocating frame slidably mounted on the base frame for horizontal sliding there over. A plurality of independent, articulating massage heads are resiliently mounted in spaced apart two dimensional array across the reciprocating frame so as to extend upwardly therefrom. A reciprocating actuator is coupled between the base frame and the reciprocating frame to cycle the reciprocating frame back and forth over the base frame. Each massage head may include a massage head actuator driving at least one orbitally reciprocating kneading head.

### CROSS-REFERENCE TO RELATED APPLICATIONS

This application is a divisional patent application of U.S. patent application Ser. No. 17/106,796 filed on Nov. 30, 2020, and entitled “Reciprocating Massage Table”, which application claims priority to U.S. Provisional patent application No. 62/941,947 and Canadian patent application no. 3,063,455, both filed on Nov. 29, 2019, and both entitled “Reciprocating Massage Table”, all of which are incorporated herein in their entirety.

### FIELD OF THE INVENTION

This invention relates to the field of back massagers and in particular to a back massaging table having individual articulating massaging heads providing orbital-motion kneading on a bed of individually corresponding springs so as to knead the user's back while the bed is simultaneously translated back and forth along the user's back.

### BACKGROUND

In the prior art applicant is aware of various back massage devices, including chairs and beds that vibrate. However, in applicant's view there exists the need for a massage table that simultaneously combines orbital kneading motions of kneading heads mounted on resiliently articulating, vertically spring supported massaging heads in a two-dimensional array of massaging heads mounted on a bed, with reciprocating motion of the bed longitudinally along and underneath the body of a user lying prone on the massage table.

In the prior art, applicant is also aware of granted Chinese utility model number CN 205083949U, which was granted on Mar. 16, 2016, for a Massage Table, and granted Chinese utility model, number CN 2297122Y, which was granted on Nov. 18, 1998, for a Massage Vibration Bed.

### SUMMARY

The reciprocating massage table according to the present specification may include a base frame, and a reciprocating frame slidably mounted on the base frame for horizontal sliding there over. A plurality of independent, articulating massage heads are resiliently mounted in spaced apart two dimensional array across the reciprocating frame so as to extend upwardly therefrom. A reciprocating actuator is coupled between the base frame and the reciprocating frame to cycle the reciprocating frame back and forth over the base frame. Each massage head may include a massage head actuator driving at least one orbitally reciprocating kneading head.

The reciprocating actuator may cycle the reciprocating frame along a substantially linear slide path.

The massage heads may each be mounted on springs interleaved between the massage heads and the reciprocating frame. For example, one spring may be mounted under each massage head. Advantageously the massage heads are free to articulate on the springs, for example by a pivotable mounting of the massage heads on supports extending journaled up through the springs.

In advantageous embodiments, the orbital reciprocating of each massage head is accomplished by crank-reciprocated orbital motion of the kneading head by a crank actuated by the massage head actuator. For example, each massage head may include a pair of crank-reciprocated orbital kneading heads, which may be a mirror image pair on opposite sides of the massage head actuator, wherein the massage head actuator operates to rotate a pair of the cranks so as to drive the orbital motion of the pairs of crank-reciprocated kneading heads.

Further advantageously, the pair of cranks may be a pair of crank wheels, wherein the crank wheels drive orbital oscillation of the kneading heads to replicate a substantially circular kneading motion in at least a substantially horizontal plane, and in some embodiments in both horizontal and vertical planes simultaneously, when the massage head is also substantially horizontal. Thus, when a user is lying prone, facing upwards, on top of the two dimensional array of massage heads so that the back of the user is supported by the array of massage heads, and the corresponding springs provide resilient conforming tilting and height adjustment of the massage heads supporting the back of the user, and wherein the reciprocating actuator moves the reciprocating frame and array of massage heads back and forth along the back of the user while simultaneously, the kneading heads provide kneading of the user's back by the orbital motion of the kneading heads under and pressing against the back of the user, whereby the back of the user is provided with at least a deep muscle massage and a release of the corresponding fascia.

In aspects of the disclosure, first and second kneading heads are rigidly mounted to the slide, adjacent the crank. In some embodiments the first kneading head upstands a greater vertical distance, orthogonal to the base of the massage head, than the second kneading head. The first and second kneading heads may be dome shaped and positioned so that corresponding vertices of the domes are oriented upwardly.

In one embodiment the slide is a slide bar mounted in a corresponding pivoting cradle mounted to the base of the massage head. In another embodiment the slide is a conformal cap, having a concave lower surface, slidably and snugly mounted on a dome, not to be confused with the dome-shaped kneading heads, rigidly mounted on the base of the massage head, wherein the crank is mounted on the dome and coupled to the slide for eccentric sliding rotation of the slide over the dome.

Yet further advantageously, for each massage head a sliding telescopically mounted guide post is slidably mounted at a base end thereof to the reciprocating frame and pivotably mounted at an opposite upper end thereof to the massage head. This provides for substantially vertical sliding of the guide post relative to the reciprocating frame. Thus, with the spring rigidly mounted at its upper and lower ends to the base of the massage head and the reciprocating frame respectively, the guide post cooperates with its corresponding spring to stabilize the spring during resilient tilting, collapse, or extension of the spring.

### BRIEF DESCRIPTION OF THE DRAWINGS

FIG. 1 is a rear perspective view of the massage table according to one embodiment of the present disclosure showing a rear corner of the cushioning cover sheets raised slightly.

FIG. 1a is a plan view of the massage table of FIG. 1, showing an outline of a user lying prone on the table.

FIG. 1b is a side elevation view of the massage table of FIG. 1.

FIG. 1c is a rear elevation view of the massage table of FIG. 1.

FIG. 1d is a plan view of the massage table of FIG. 1, showing line 4-4 as being the location of the cross-section of FIG. 4.

FIG. 2 is the front perspective view of the massage table of FIG. 1 with the covering sheets removed to expose the two-dimensional array of massaging heads resiliently mounted on the reciprocating frame.

FIG. 2a is a perspective view of a further embodiment of the massage table with the covering sheets removed, and showing the reciprocating frame slidably mounted on the base frame for longitudinal back and forth sliding motion.

FIG. 3 is a perspective bottom view of the massage table of FIG. 1.

FIG. 4 is a cross-section along line 4-4 in FIG. 1d.

FIG. 4a is, in side elevation view, a further embodiment of the massage table showing a slightly altered lifting frame and loading platform.

FIG. 4b is, in end elevation view, the massage table of FIG. 4a.

FIG. 4c is, in plan view, the massage table of FIG. 4a.

FIG. 4d is, in side elevation view, the reciprocating frame of FIG. 4a with its bed of massage heads spring-mounted thereon in the spaced array seen in FIG. 4c.

FIG. 4e is an end view of the reciprocating frame and bed of spring-mounted massage heads of FIG. 4d.

FIG. 5 is an enlarged view of a portion of FIG. 4 showing the longitudinal drive mechanism for sliding the reciprocating frame along the base frame.

FIG. 6 is a side elevation view of one embodiment of a massage head on its spring and support post.

FIG. 6a is a perspective view of the massage head of FIG. 6 compressing its spring vertically downwards.

FIG. 7 is a plan view of the massage head of FIG. 6 showing the orbital motion of its kneading heads.

FIG. 8 is a cross-section along line 8-8 in FIG. 7 showing the resilient tilting of the massage head on its spring, and the telescopic vertical sliding of the support post supporting the massage head on its spring.

FIG. 9 is an enlarged view of a portion of FIG. 1.

FIG. 10 is, in perspective view, a further embodiment of a massage head.

FIG. 11 is, in plan view, the massage head of FIG. 10.

### DESCRIPTION OF PREFERRED EMBODIMENTS

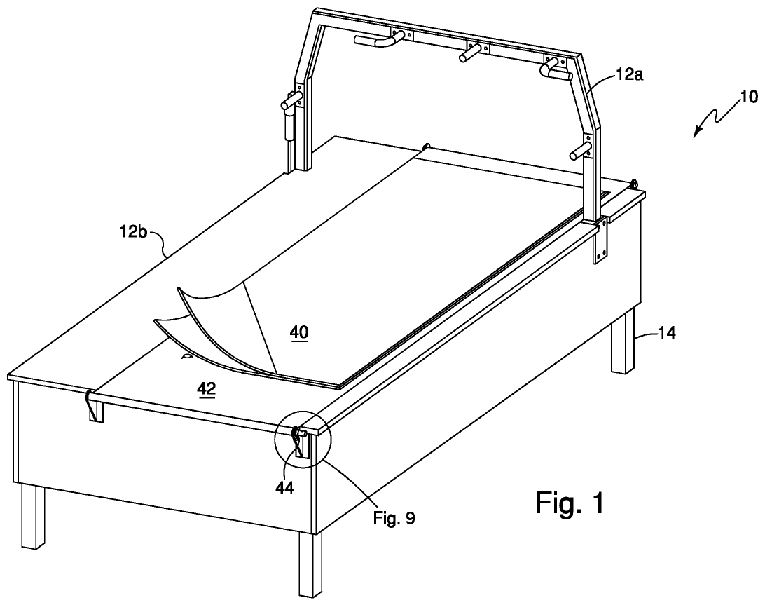

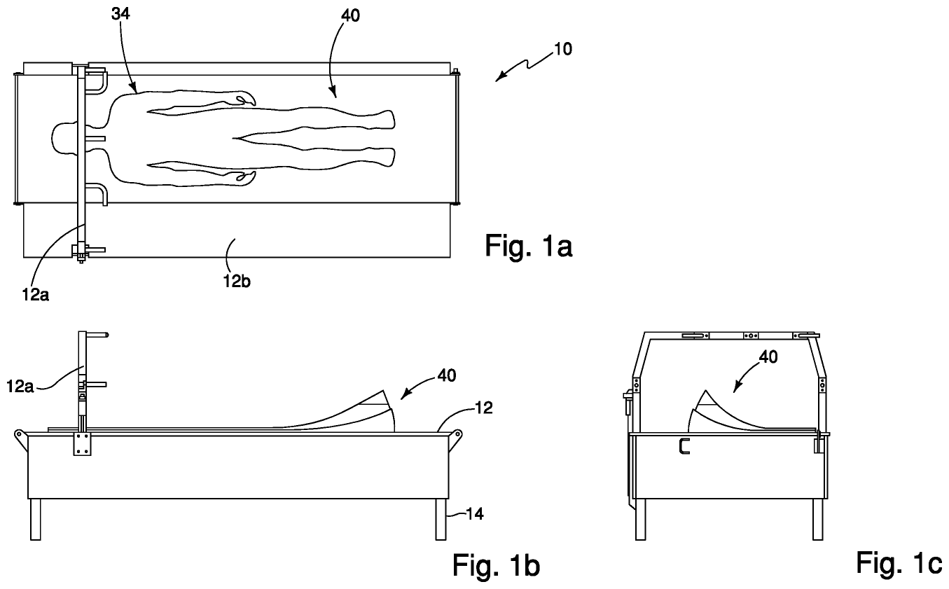

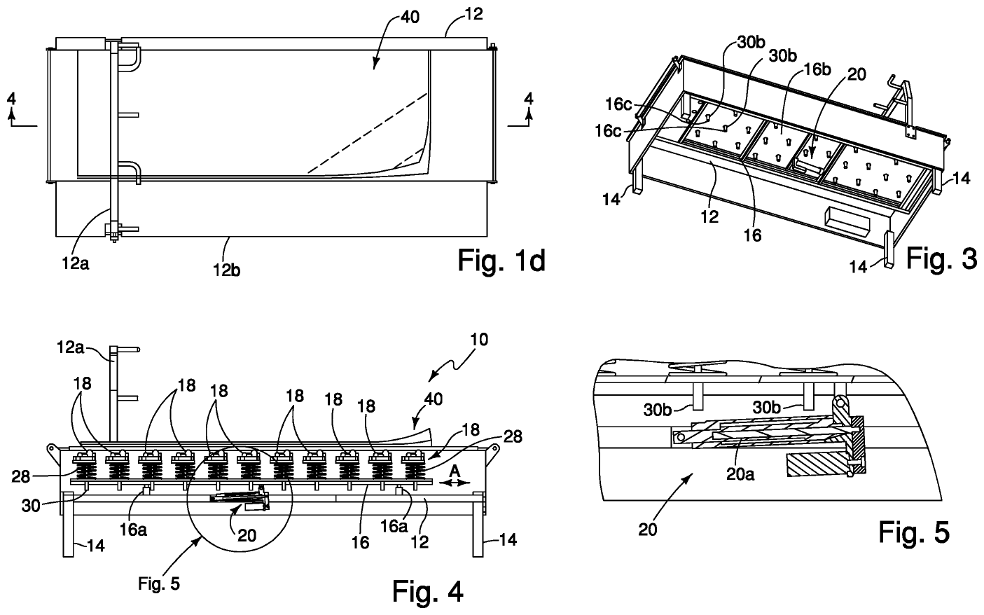

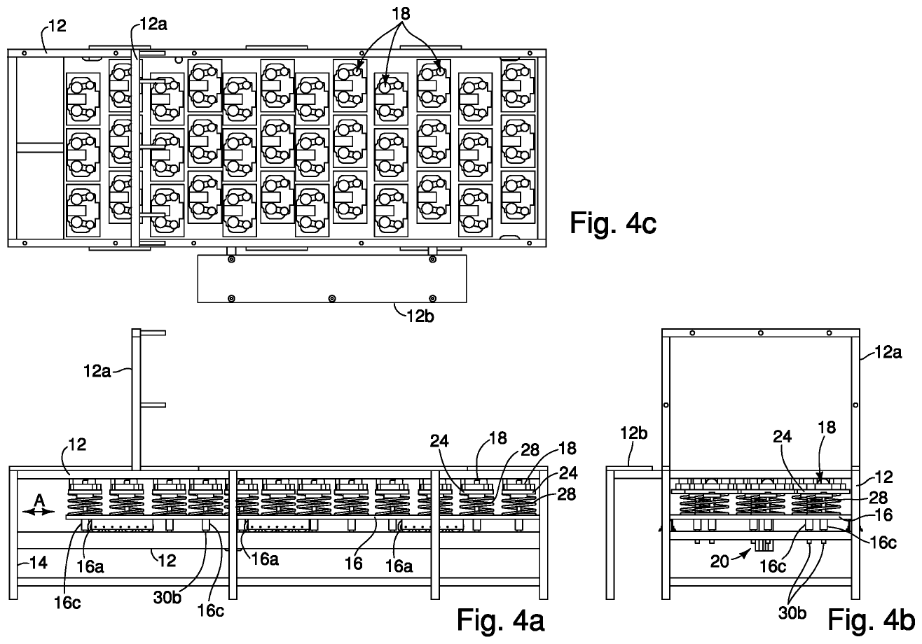

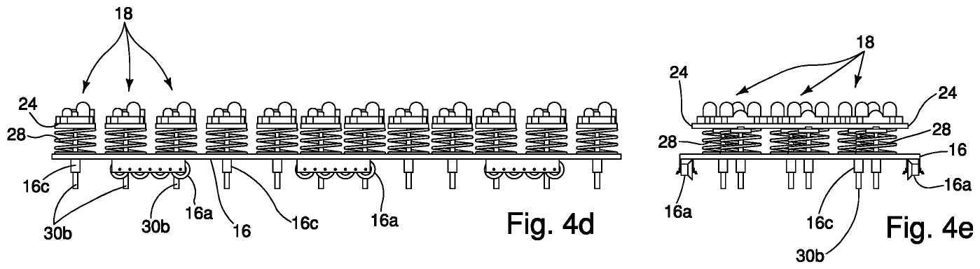

As seen in the accompanying drawing figures, wherein like reference numerals depict corresponding parts in each view, as seen in FIGS. 1, one embodiment of the reciprocating massage table 10 according to this specification includes a base frame 12 supported on legs 14. As seen in FIGS. 4 and 4a, reciprocating frame 16 is slidably mounted on the base frame 12, for example by means of wheels 16a, for horizontal sliding on wheels 16a of reciprocating frame 16 over base frame 12 in direction A. Other forms of low friction sliders would also work as would be known to one skilled in the art.

In a preferred embodiment, a lifting frame 12a and loading platform 12b are mounted to base frame 12. Lifting frame 12a and loading platform 12b assist a user in mounting and dismounting from massage table 10.

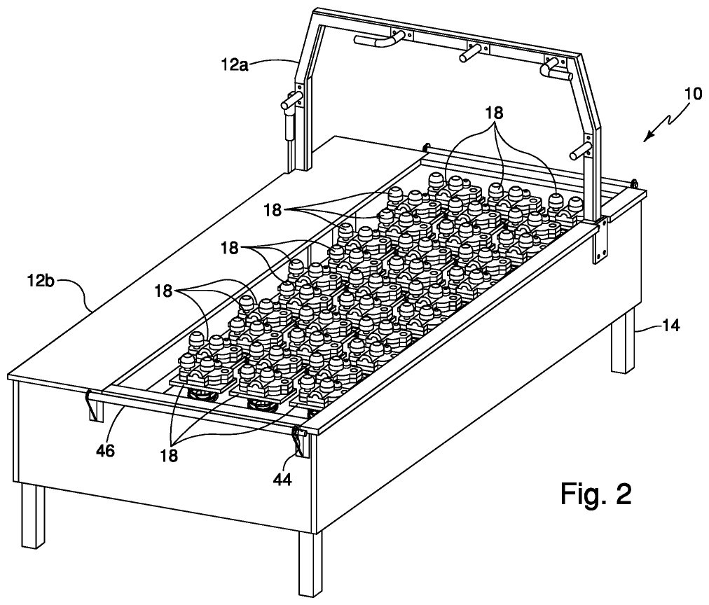

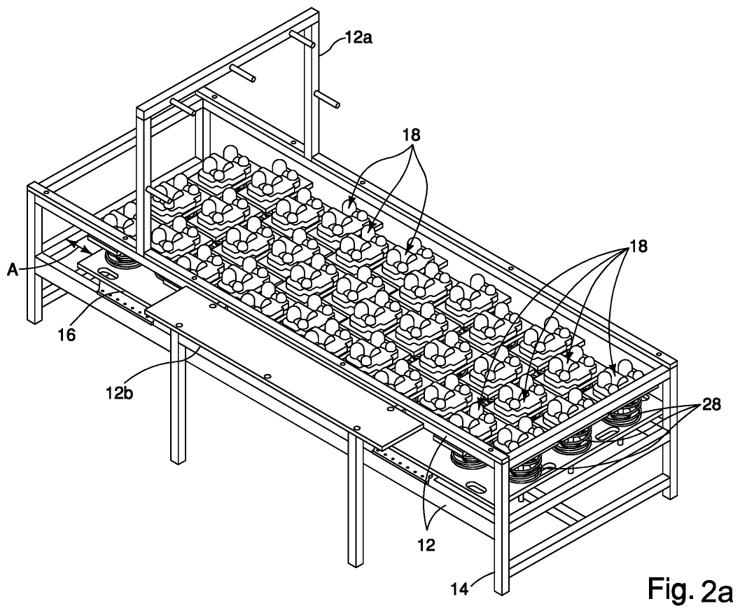

As seen in FIG. 2, a plurality of independent massage heads 18 are resiliently mounted in spaced apart two dimensional array to and across the length and width of reciprocating frame 16. Massage heads 18 extend upwardly resiliently supported on springs 28 at a uniform elevation when uncompressed, above reciprocating frame 16. When the springs are uncompressed such as seen in FIGS. 4 and 4a, base plates 24 lie in a common, horizontal plane. As seen in FIGS. 3-5, a reciprocating actuator 20 is coupled between the base frame 12 and the reciprocating frame 16 to cycle the reciprocating frame 16 back and forth longitudinally in direction A over the base frame 12. In the depicted embodiment, which is not intended to be limiting, the reciprocating actuator 20 cycles the reciprocating frame 16 in direction A along a substantially linear slide path corresponding to the length of the stroke of the actuator. The reciprocating actuator 20 may be a linear actuator such as the screw drive 20a illustrated, or may be hydraulic or pneumatic actuators or other actuators which would be known to one skilled in the art.

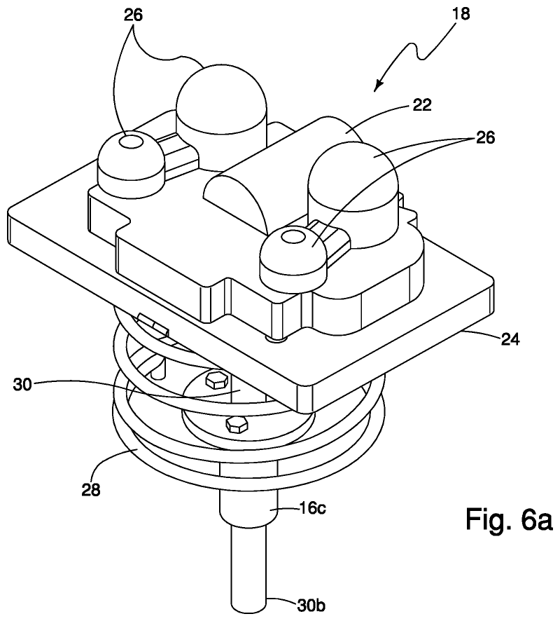

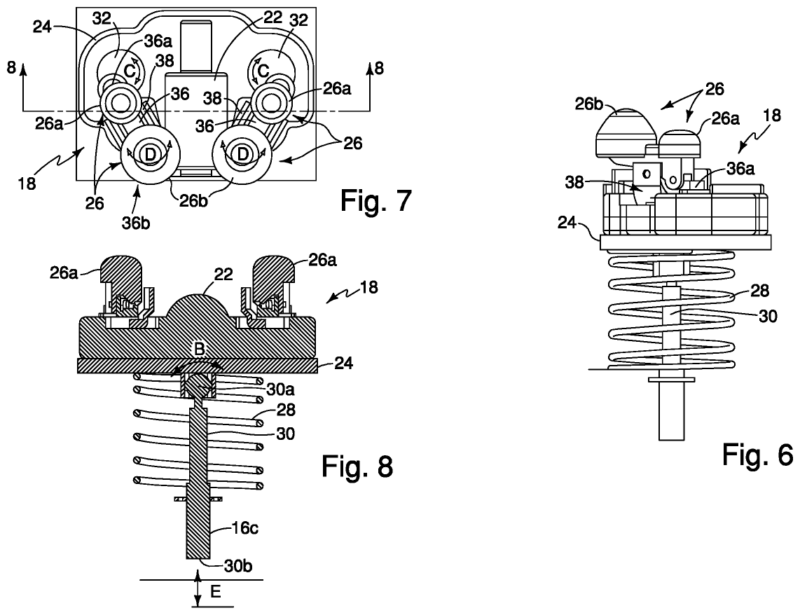

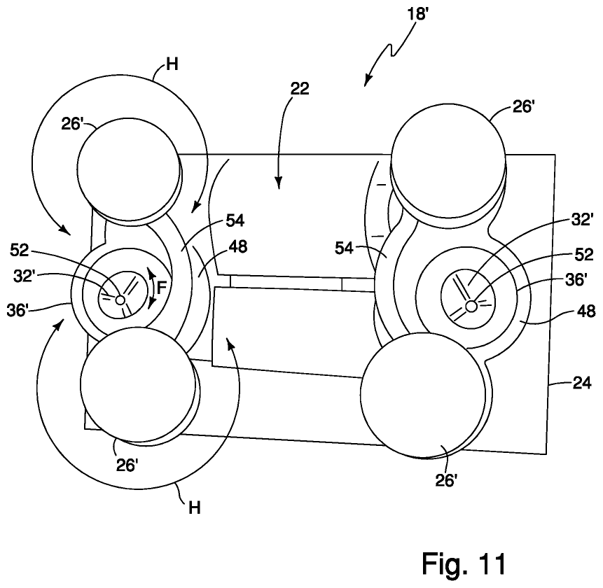

As seen in FIGS. 6-8, each massage head 18 includes a massage head actuator 22, which may include an electric motor or step motor (not shown), mounted on base plate 24. The massage head actuator drives the motion of at least one, and preferably multiple, kneading heads 26, for example the illustrated crank-reciprocated kneading heads 26 best seen in FIG. 7 and in a further embodiment, in FIGS. 10 and 11.

Advantageously the plurality of independent massage heads 18 are each mounted on the springs 28. Springs 28 are stabilized and guided by guide posts 30 extending orthogonally between the massage heads 18 and the reciprocating frame 16. In particular, in the depicted embodiment base plate 24 of FIG. 8, again without intending to be limiting, one spring 28 and corresponding guide post 30 is shown supporting the spring 28 and massage head 18 against both lateral or sideways, and front-to-back or longitudinal movement relative to frame 16. There is no weight bearing by the guide post as the guide post is free to slide vertically such as the telescopic sliding in sleeve 16c. Weight bearing is on the spring 28, which is then transmitted to the reciprocating frame 16, so that the reciprocating table, and the base frame thereunder, fully bears the weight of the user. Guide posts 30 are mounted under the base plate 24 of each massage head 18 to provide the resiliently vertical floating of the massage heads 18 above the reciprocating frame 16 when springs 28 are absorbing the weight of a user lying on the bed. The guide posts 30 are mounted vertically on reciprocating frame 16 with the base ends 30b of the guide posts 30 extending through and slidably mounted in sleeves 16c for vertical sliding in direction E of guide posts 30 relative to a horizontal support plate 16b on frame 16. The upper ends of the guide posts provide for pivoting of the base plates about the upper ends of the guide posts, against the resilient return biasing force of the springs, rigidly mounted at their base ends onto the reciprocating frame.

In the illustrated example, guide posts 30 provide the alignment for the two dimensional array of massage heads 18. The two dimensional array may include, without intending to be limiting, twelve rows of three massage heads 18 per row as depicted, for a total of thirty-six massage heads 18. An array of springs 28 are thus provided in sufficient number and having sufficient compressive strength, bearing on reciprocating table 16 so that collectively the two dimensional array of springs 28 will support the weight of a user lying prone on the two dimensional massage heads 18. Meanwhile, guide posts 30 hold lateral and longitudinal alignment of the base 24 and massage heads 18 attached thereto. Guide posts 30 slide up and down, and the springs 28 resiliently tilt (by pivoting on their guide post), collapse or expand correspondingly, to provide a body contoured, articulating alignment of the array of massage heads 18, thereby giving comfort to the user.

Advantageously, ball joints 30a may be provided on the upper end of support posts 30 provide limited tilting articulation in direction B so that the massage heads 18 are tiltable relative to guide posts 30 against the return resilient biasing force of springs 28 which bias the massage heads 18 back to level. For example, ball joint 30a may permit a tilt angle of up to approximately 20 degrees relative to reciprocating table 16.

In the embodiment of FIGS. 6-8, pairs of crank-reciprocated kneading heads 26 are operatively disposed on opposite sides of the massage head actuator 22. As would be known to one skilled in the art, the massage head actuator 22 may be a DC step motor driving a mechanical linkage (not shown) so as to drive the cranks which provide the kneading motion for the kneading heads 26. Without intending to be limiting, the cranks may be for example crank wheels 32.

The pairs of crank-reciprocated kneading heads 26 may, in the example of FIGS. 6 and 7, reciprocate in a plane substantially parallel to the plane of base plate 24 so as to remain substantially level or horizontal when the base plates 24 of massage heads 18 are also substantially level or horizontal. Alternatively, such as seen in the embodiment of FIGS. 10 and 11, and as described below, the pairs of kneading heads 26 may reciprocate with a three dimensional orbital motion relative to the plane of the base plates 24. In the depicted embodiment of FIGS. 6 and 7, the kneading heads 26 are a mirror image pair of kneading heads disposed on opposite sides of the massage head actuator 22. Thus as seen, the massage head actuator 22 may bisect the base 24 of the massage heads 18. Each of the pair of kneading heads 26 may include forward and rear, or first and second, individual kneading heads 26a and 26b respectively. Thus the forward kneading head 26a may be closer to the head of the user 34 lying on the massage table 10, and the rear kneading head 26b may be further away from the head of the user 34. As seen in the drawings, the rear kneading heads 26b may protrude upwardly from the massage head 18 further than the forward kneading heads 26a.

The kneading heads 26 of FIGS. 6 and 7 are mounted onto horizontal slide arms 36, with the forward kneading head 26a at the forward end 36a of the slide arm 36 and the rear kneading head 26b at the rear end 36b of the slide arm 36. Slide arms 36 are pivotally mounted, at forward or first ends 36a, to the crank wheels 32. The slide arms 36 are slidably mounted on corresponding pivotally mounted slide cradles 38 pivotally mounted on the base plate 24 of the massage head 18. Thus, as the crank wheels 32 rotate in direction C when driven by the massage head actuator 22 the slide arms 36 correspondingly follow a circular path prescribed by the motion of the crank wheels 32 thereby oscillating the kneading heads 26 to replicate a substantially circular or orbital kneading motion as for example in direction D (shown as arrows herein but understood to represent cyclical orbital motion).

The kneading motion lies in a substantially horizontal or level plane when the massage head is also substantially horizontal or level, keeping in mind that the massage heads will tilt on their springs 28 and the ball joints 30a on support posts 30 when the user is lying on the massage table in order to conform the tilt of the massage heads 18 to the shape of the user's body, and in particular the contours of the user's back. Thus, when a user 34 is lying prone, facing upwards, on top of the two dimensional array of massage heads 18 so that the back of the user 34 is supported by the array of massage heads 18 (with sheets 40 and 42 between the user and the massage heads), the reciprocating actuator 20 moves the reciprocating frame 16 and array of massage heads 18 back and forth along the back of the user 34 and the massage heads 18 tilt to conform to the user's back as the reciprocating frame 16 is traversed longitudinally under the user 34. This is complimented by the depression of springs 28 moving up and down vertically on guide posts 30.

Simultaneously, as the reciprocating frame 16 is traversed under the user's back, the massage head actuators 22 oscillate the kneading heads 26 in their orbital kneading motion D under, and pressing upwardly against, the back of the user 34.

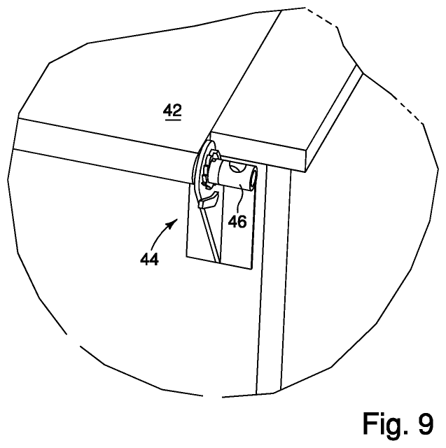

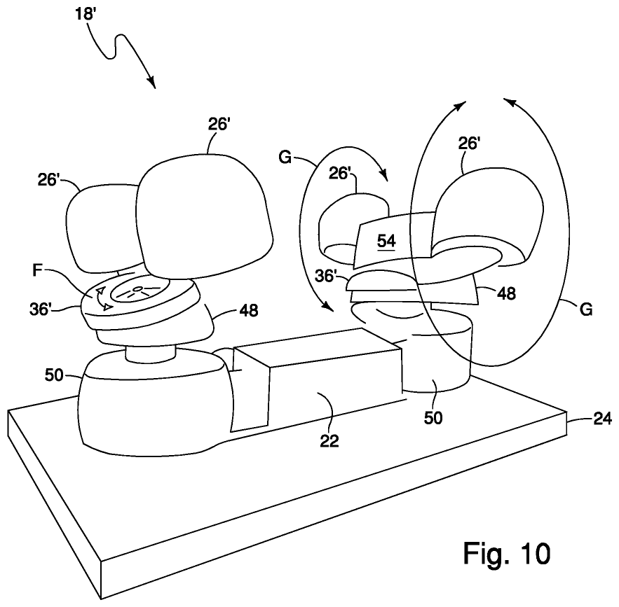

As mentioned above, in a preferred embodiment a sheet or sheets 40 of flexible cushioning material, such as for example an elastomer or Nylon™ mat, and a Nylon™ meshed material, or for example a foam-rubber sheet, is or are overlaid on the massage heads 18 so as to provide a flexible resilient cushioning sheet 40 supported by Nylon™ sheet 42, which is preferably rip-stop, between the kneading heads 26 and the back of the user 34. As used herein, Nylon™ refers to the family of synthetic polymers based on aliphatic or semi-aromatic polyamides. Sheet 42 may in one embodiment be tensioned around shaft 46 by ratcheting tensioners 44 seen in FIG. 9. In another embodiment, not intended to be limiting, the rear end of sheet 42, which may for example be between 30 and 36 inches wide, may be secured to the length of shaft 46, and tensioned by means of tensioners located at the front end of sheet 42. An example of tensioners that would work, as would be known to one skilled in the art, would be over-center latches pulling on a rod or shaft secured across the width of the front end of sheet 42.

In the embodiment of FIGS. 2 and 6-8, and as stated above, each massage head 18 includes a pair of oppositely disposed sets of kneading heads 26, wherein each set of kneading heads 26 includes the forward and rear kneading heads 26a, 26b. Again, each set of kneading heads 26 is actuated by a corresponding crank, such the depicted crank wheels 32, which are actuated by the massage head actuator 22. Each set of kneading heads 26 includes first and second, or forward and rear, kneading heads 26a, 26b. The first kneading head is mounted closely adjacent the corresponding crank wheel 32 on a first end 36a of the slide arm 36. The second kneading head 26b is mounted on an opposite second end of the slide arm. The slide arm slides and rotates to provide the circular kneading motion for the kneading heads as the slide arm follows the circular cranking motion of the crank wheels 32, relative to the base 24 of the massage head 18.

The slide arms 36 are mounted in corresponding pivoting slide cradles 38 which are pivotally mounted to the base 24 of the massage head 18.

The first or forward kneading head 26a upstands a first distance orthogonal to the base 24 of the massage head 18, and the second or rear kneading head 26b upstands a second distance orthogonal to the base 24 of the massage head 18. In the depicted embodiment, not intended to be limiting, the second distance is greater than the first distance. Further, and again not intended to be limiting, the first kneading head 26a has a first diameter and the second kneading head 26b has a second diameter, and the second diameter is greater than the first diameter. The first and second kneading heads 26a, 26b may be for example have a ball or domed or spherical or frusto-conical shape (collectively referred to herein as being domes) and are positioned on the slide arms so that the corresponding tips or vertices of the domes are oriented upwardly. Again, the rear or second domes may be larger than the forward or first domes.

The stroke of the reciprocating actuator 20 may for example be in the range of six to twelve inches, and again by way of example may preferably be in the range of substantially 10 inches, and in one embodiment 8.5 inches. In these examples the reciprocating actuator 20 may be adapted to actuate the timing of the actuator's stroke, in one direction, in the range of 15 to 60 seconds, and adapted to actuate different timing for each of the forward and back strokes. Thus if the reciprocating actuator 20 is a screw drive having a stroke of about 10 inches, then, if the reciprocating actuator actuates the length of its stroke in substantially 20 seconds in a first direction, for example forward, and substantially 20 seconds in an opposite second direction, the actuator's direct current step motor need only move the reciprocating frame at a constant rate of about 0.5 inches per second.

In a further embodiment of the massage heads 18, and not intended to be limiting, massage heads 18′ are seen in FIGS. 10 and 11. Massage heads 18′ illustrate an example of other forms of massage heads that may be mounted on base plates 24. In the embodiment of FIGS. 10 and 11, two pairs of kneading heads 26′ are mounted on base plate 24 on opposite sides of actuator 22. As described above, actuator 22 may be an electric motor such as a direct current step motor driving rotation of a pair crank wheels. Each pair of kneading heads is given an orbital motion by a corresponding crank wheel to provide part of the massage table's kneading function. As described above, the other part of the kneading function is provided by the reciprocating action of the reciprocating frame sliding back and forth over the base frame.

As seen in FIGS. 10 and 11, in this embodiment, instead of a slide arm 36 connecting the corresponding pair of kneading heads 26 and sliding along a slide cradle 38 in response to orbital actuation by the corresponding crank wheel 32, crank wheel 32′ drives an orbital rotation of a slide cap 36′. Slide cap 36′ conformally sits on top of its corresponding hemispherical dome 48. Dome 48 is rigidly mounted on base 50. Base 50 is mounted on base plate 24. Actuator 22 drives rotation of a drive shaft 52 coupled to the hub of crank wheel 32′. Drive shaft 52 extends up from base 50 and vertically through dome 48 so as to couple to the crank wheel 32′ mounted thereon. Crank wheel 32′ is eccentric and drives a correspondingly eccentric orbital motion in direction F of slide cap 36′ as it slides smoothly and snugly over the top of dome 48. Because kneading heads 26′ are rigidly mounted onto slide cap 36′ by means of mounting bracket 54, the orbital motion of slide cap 36′ sliding over dome 48 translates into simultaneous orbital motion of kneading heads 26′. In particular, the orbital motion of slide cap 36′ translates into simultaneous orbital rotation of kneading heads 26′, broken down into the components of their motion, in vertical orbits G seen illustrated by way of example in FIG. 10, simultaneously with horizontal orbits H seen illustrated by way of example in FIG. 11. Orbits H are referred to as being horizontal in the sense that the orbit component H of the orbital motion of the kneading heads is in a plane which is parallel to base plate 24, and orbit component G of the orbital motion of the kneading heads is in a plane which is orthogonal to base plate 24. It is understood that, although the component orbital motions G and H are only shown with respect to a single pair of kneading heads 26′ in FIGS. 10 and 11, that the orbital motion of the other pair of kneading heads 26′ would be comprised of the same vertical and horizontal components.

1. A reciprocating massage table comprising:
a base frame,
a reciprocating frame slidably mounted on the base frame for horizontal sliding there over,
a plurality of independent massage heads resiliently mounted in spaced apart two dimensional array across the reciprocating frame so as to extend upwardly therefrom, wherein the plurality of individual massage heads are each mounted on springs interleaved between the massage heads and the reciprocating frame,
a sliding telescopically mounted guide post slidably mounted at a base end thereof to the reciprocating frame and pivotably mounted at an opposite upper end thereof to a corresponding massage head of the plurality of massage heads, for substantially vertical sliding of the guide post relative to the reciprocating frame wherein the spring is rigidly mounted at its upper and lower ends to the base of the massage head and the reciprocating frame respectively and wherein the guide post cooperates with a corresponding spring of the springs to stabilize the corresponding spring during resilient tilting, collapse, or extension of the spring,
a reciprocating actuator coupled between the base frame and the reciprocating frame to cycle the reciprocating frame back and forth over the base frame,
wherein each massage head of the plurality of independent massage heads includes a massage head actuator, the massage head actuator driving at least one orbitally reciprocating kneading head.

2. The massage table of claim 1 wherein the reciprocating actuator cycles the reciprocating frame along a substantially linear slide path.

3. The massage table of claim 1 wherein one spring of the springs is mounted under each massage head of the plurality of independent massage heads for said resilient mounting of the massage heads onto the reciprocating frame.

4. The massage table of claim 1 wherein the orbital reciprocating of each kneading head is crank-reciprocated orbital kneading of the kneading head by a crank actuated by the massage head actuator.

5. The massage table of claim 4 wherein each massage head of the plurality of independent massage heads includes a pair of crank-reciprocated orbital kneading heads.

6. The massage table of claim 5 wherein the kneading heads are a mirror image pair on opposite sides of the massage head actuator.

7. The massage table of claim 6 wherein each kneading head of the mirror image pair include first and second kneading heads.

8. The massage table of claim 4 wherein the massage head actuator operates to rotate a pair of the cranks so as to drive orbital motion of a pair of the crank-reciprocated kneading heads.

9. The massage table of claim 8 wherein the pair of cranks are a pair of crank wheels.

10. The massage table of claim 9 wherein the crank wheels drive orbital oscillation of the kneading heads to replicate a substantially circular kneading motion in at least a substantially horizontal plane when the massage head is also substantially horizontal, and whereby, when a user is lying prone, facing upwards, on top of the two dimensional array of massage heads so that the back of the user is supported by the array of massage heads, and the corresponding springs provide resilient articulating of the massage heads, conforming tilting and height adjustment of the massage heads supporting the back of the user, and wherein the reciprocating actuator moves the reciprocating frame and array of massage heads back and forth along the back of the user while simultaneously the kneading heads provide kneading by the orbital motion of the kneading heads under and pressing against the back of the user, whereby the back of the user is provided with at least a deep muscle massage and release of the corresponding fascia.

11. The massage table of claim 1 whereby, when a user is lying on top of the two dimensional array of massage heads so that the body of the user is supported by the array of massage heads, and the corresponding springs provide resilient articulating of the massage heads, conforming tilting and height adjustment of the massage heads supporting the back of the user, and wherein the reciprocating actuator moves the reciprocating frame and array of massage heads back and forth along the back of the user while simultaneously the kneading heads provide kneading by the orbital reciprocation of the kneading heads under and pressing against the back of the user, and the weight of the user is supported on the array of massage heads and the reciprocating frame.

12. The massage table of claim 8 wherein each kneading head of the pair of kneading heads includes first and second kneading heads, and wherein the first and second kneading heads are rigidly mounted to the slide and adjacent the crank.

13. The massage table of claim 12 wherein the first kneading head upstands a first distance orthogonal to the base of the massage head, and the second kneading head upstands a second distance orthogonal to the base of the massage head, and wherein the second distance is greater than the first distance.

14. The massage table of claim 12 wherein the first and second kneading heads are dome shaped and positioned so that corresponding vertices of the domes are oriented upwardly.

15. The massage table of claim 12 wherein the slide is a slide arm mounted in a corresponding pivoting cradle mounted to the base of the massage head.

16. The massage table of claim 12 wherein the slide is a conformal cap slidably and snugly mounted on a dome rigidly mounted on the base of the massage head, and wherein the crank is mounted on the dome and coupled to the slide for eccentric sliding rotation of the slide over the dome.

17. The massage table of claim 1 wherein the stroke of the reciprocating actuator is in the range of six to twelve inches.

18. The massage table of claim 17 wherein the reciprocating actuator is adapted to actuate the time of the stroke in one direction in the range of 15 to 60 seconds, and that the timing of each stroke, forwards and backwards, may be independent of each other so that the timing of the forward stroke may be different than the timing of the rearwards stroke.

19. The massage table of claim 18 wherein the reciprocating actuator actuates the stroke in substantially 20 seconds in a first direction and substantially 20 seconds in an opposite second direction.

20. The massage table of claim 12, wherein the crank is a crank wheel, the crank wheel connected to a drive shaft extending up from the base and through the dome, the drive shaft driven by the massage head actuator.
